(19) United States
(12) Patent Application Publication
(10) Pub. No.: US 2013/0051003 A1
(43) Pub. Date: Feb. 28, 2013

(54) LED Lighting Device with Efficient Heat Removal

(71) Applicant: Chenjun Fan, Ottawa (CA)

(72) Inventor: Chenjun Fan, Ottawa (CA)

(73) Assignee: Chenjun Fan, Ottawa (CA)

(21) Appl. No.: 13/594,004

(22) Filed: Aug. 24, 2012

Related U.S. Application Data
(60) Provisional application No. 61/527,803, filed on Aug. 26, 2011.

(51) Int. Cl. F21V 29/02; B23P 17/04; F21V 7/00; F21V 9/16; F21V 3/00; F21V 29/00

(52) U.S. Cl. 362/231; 362/249.02; 362/235; 362/247; 29/428

(57) ABSTRACT

A solid-state light emitting diode (LED) lighting device is disclosed for use in general lighting. In the preferred embodiment, the LED lighting device comprises a heat sink having at least one opening, an output globe having at least one opening, and at least one ventilation channel. This channel helps to remove heat from the LED lighting device. An active cooling device is further installed inside the channel for very efficient heat removal. As a result, even at high luminous output, the LED lighting device is kept in a relatively small form factor. In some preferred embodiments, remote wavelength conversion luminescent phosphor particles or color mixing are utilized to achieve warm white lighting with high efficacy and high color rendering index (CRI). The LED lighting device has high luminous output, glare-free illumination, omni-directional distribution, and good color reproduction.

### CROSS-REFERENCE TO RELATED APPLICATIONS

This application claims priority of U.S. Provisional Patent Application No. 61/527,803 filed on Aug. 26, 2011, entitled “LED Lighting Device with Effective Heat Removal” which is incorporated herein by reference for all purposes.

### FIELD OF THE INVENTION

This invention generally relates to solid-state lighting devices, as well as related components, systems and methods, and more particularly to methods to make an LED light bulb with high luminous output and omni-directional distribution.

### BACKGROUND OF THE INVENTION

It is well known that incandescent light bulbs are very inefficient in terms of energy utilization. About 90% of the electricity they consume is released as heat rather than light, and an even much smaller portion generates visible light. For lighting purpose, fluorescent light bulbs are about 10 times more efficient, and solid-state semiconductor light emitting diodes are about 20 times more efficient.

Because solid-state semiconductor light emitters are environmentally friendly and have a big potential in energy saving and long operation life in comparison with traditional lighting devices, solid-state light emitting apparatus are being widely designed and marketed as replacements for conventional incandescent lighting apparatus. There have been considerable efforts to replace incandescent light bulb using solid-state LEDs. However, most of the existing LED light bulbs suffer at least one of the following shortcomings:

Today's LED light bulbs can only deliver up to 850 lumens in a form factor equivalent to the output of 60 W incandescent light bulbs. Although tremendous progress has been made to improve the light emission efficiency of solid-state LEDs in the past 20 years, as of today, they only manage to covert less than 20% electrical power into visible light, while the rest is still being released as heat. Unlike an incandescent light bulb that can effectively dissipate heat through radiation, LEDs mainly rely on conduction and convection by using heat sinks for heat removal. As the luminous output increases, the required heat sink volume has to increase to keep the LEDs operating within an acceptable temperature range. As a result, the LED lighting apparatus becomes very bulky. It is a daunting challenge for LED lighting devices to deliver an equivalent luminous output in a size comparable to incandescent light bulbs.

The LED sources are usually mounted on a PCB board that resides in the center area of the LED light bulb and within an enclosure inside the LED light bulb. There is a relatively long path for the heat to travel to the outer surface of the heat sink. As a result, the thermal resistance is so high as to cause high junction temperature in LEDs. Running an LED at elevated temperature reduces its emission efficiency and its operation life due to degradation and premature failures.

The LEDs known in the art extract the light in a forward direction. Although they can have a far field distribution as wide as up to 180 degrees, most general lighting applications require near omni-directional (more than 300 degrees) light distribution. Most existing LED light bulb can only manage to deliver a light distribution of about 180 degrees. Moreover, most of the existing LED light bulbs do not have a shape and form factor that closely match consumer preferences for an incandescent light bulb's look and feel. The expectation of the consumers remains unmet.

To facilitate better thermal management and combat issues such as glare and multiple source shadow, most existing LED light bulbs use a relatively large number of LEDs with relatively smaller chip size, which are run at relatively lower current. This approach makes the LED light bulb relatively bulky and less reliable, as well as increases both material cost and manufacturing cost.

There is a need for an improved LED light bulb that delivers omni-directional distribution with high luminous efficacy, high luminous output, and reduced cost in a shape and form factor comparable to incandescent light bulbs.

### SUMMARY OF THE INVENTION

The need is met by the present new, useful, and non-obvious invention.

While various shapes of the lighting devices are within the scope of the present invention, the preferred embodiment of the present invention has a shape and form factor resembling the incandescent light bulb. In a particular preferred embodiment, the combined shape of the heat sink and the output globe forms a standard A19 light bulb shape.

In one preferred embodiment, the LED lighting device of the present invention comprises an electrical connector, an electrical AC/DC conversion and control driver, a driver housing, a heat sink, a plurality of semiconductor light emitting diodes (LEDs), a reflective cap, an air pipe, and an output globe. The heat sink and the air pipe form a channel substantially around the centerline of the LED lighting device. Both the output globe and the heat sink have openings to provide air intake or exhaust for the channel. When the lighting device is turned on, the heat generated by the LEDs and the driver will heat the air inside the channel, and the warm air rises and creates a convective force. This convective force will help move the air through the channel and remove heat from the lighting devices. In another preferred embodiment, the LED lighting device of the present invention uses an active cooling device such as a cooling fan or a synthetic jet inside the channel to introduce forced convection for further improvement of heat removal. These arrangements reduce the required heat sink volume greatly. Therefore, the lighting device with high luminous output can still have a form and shape factor similar to traditional incandescent lighting apparatus.

The electrical power connector of the lighting device may be a standard Edison-type screw connector such that the lighting device can be used to replace a standard incandescent light bulb.

The heat sink, according to the preferred embodiment of the present invention, has a cylindrical main body with fins on its outside surface for heat dissipation. Inside the heat sink, a cutout substantially around the centerline in the upper portion forms an upper housing to host the electronics, which include the electrical AC/DC conversion and control driver and the active cooling device if used. The heat sink has a frustum extended down from its cylindrical main body. This frustum has a plurality of side surfaces. The LEDs are mounted on these side surfaces and emit light outwards and slightly downwards. Inside the frustum, there is a hole connecting the frustum's top surface to the cutout in the upper portion so that a tunnel is formed substantially around the centerline of the heat sink. An air channel is then formed after attaching the air pipe to the frustum's opening.

The output globe according to the preferred embodiment of the present invention has a hemisphere shape with a diameter larger than the diameter of the heat sink's main cylindrical body. Also, the upper portion of the output globe is shaped in such a way that its opening can have a tight fit with the heat sink's main cylindrical body. Together with the air pipe, the output globe and the heat sink form an airtight space surrounding the LEDs. In one preferred embodiment, the output globe is made of translucent material with a substantial amount of light being diffusively reflected. Part of the reflected light will be recycled by the reflective cap. A substantial portion of the reflected light will go through the gaps between the fins to reach the upper hemisphere so that omni-directional lighting is realized. In some other preferred embodiments, the output globe comprises two separate pieces: the upper cover and the lower globe. The upper cover is made of substantially transparent material, while the lower globe is made of translucent material with a substantial amount of light being diffusively reflected. Part of the reflected light will be recycled by the reflective cap. A substantial portion of the reflected light will go through the upper cover and the gaps between the fins to reach the upper hemisphere. Therefore, omni-directional lighting is realized

The LED typically consists of a light-emitting element called the LED die or LED chip, a chip carrier called the sub-mount, electrical leads, a thermal conductive pad, and a lens. The sub-mount is usually thermally conductive but electrically non-conductive. More than one LED chip can be packaged into the same sub-mount as well. The LEDs are commercially available from a number of manufacturers, such as Cree, Philips Lumileds, and Osram. These manufacturers also supply LEDs with or without phosphors included in the package. Cool white light LEDs and warm white light LEDs are commercially available from Cree, Philip Lumileds, Osram, etc. These LEDs can be used in the present invention to produce a complete LED lighting device with color rendering index (CRI) specified by the LED vendors. The LED lighting device of the present invention may utilize a few groups of LEDs to achieve the desired color rendering index (CRI) in some embodiments, with each group of LEDs emitting a different dominant wavelength. Different colors of light are mixed within the output globe.

There have been extensive studies on achieving warm white light using blue LEDs or near-UV LEDs in combination with remote phosphors. Blue light LEDs or near-UV LEDs are commercially available from Cree, Philip Lumileds, Osram, etc. In some preferred embodiments of the present invention, these LEDs can be used together with the remote phosphor caps to produce a complete LED lighting device with high color rendering index (CRI). These remote phosphor caps are made of substantially transparent plastic material that is embedded with wavelength conversion luminescent phosphor particles. In some other embodiments, the LED lighting device of the present invention may utilize a first group of blue or UV LEDs that are capped by the remote phosphor caps, and a second group of green or red LEDs. This second group of green or red LEDs are to make up for the color deficiency of the light emerging from the remote phosphor caps. Different colors of light are mixed within the output globe. As a result, high color rendering index (CRI) is achieved.

Other aspects and advantages of the present invention will become apparent from the following detailed description, taken in conjunction with the accompanying drawings, illustrating by way of example the principles of the invention.

### BRIEF DESCRIPTION OF THE DRAWINGS

FIG. 1 illustrates the preferred shape of the LED lighting device according to the present invention.

FIG. 2 is the exploded view of a preferred embodiment of the LED lighting device according to the present invention.

FIG. 3 is the cross section view of an LED lighting device according to the present invention.

FIG. 4a and FIG. 4b illustrate the heat sink of a preferred embodiment according to the present invention viewed from two different angles.

FIG. 5a illustrates the air pipe of a preferred embodiment according to the present invention.

FIG. 5b illustrates the reflective cap of a preferred embodiment according to the present invention.

FIG. 6a illustrates the output globe in some of the preferred embodiments according to the present invention.

FIG. 6b illustrates the output globe comprising two pieces in some other preferred embodiments according to the present invention.

FIG. 7 is the side view of a typical LED.

FIG. 8 illustrates the preferred shape of a first embodiment of the LED lighting device according to the present invention.

FIG. 9 is the exploded view of a first embodiment of the LED lighting device according to the present invention: without remote phosphor and active cooling device.

FIG. 10 illustrates the preferred shape of a second embodiment of the LED lighting device according to the present invention.

FIG. 11 is the exploded view of a second embodiment of the LED lighting device according to the present invention: without remote phosphor and with active cooling device.

FIG. 12 is the side view of a typical LED mounted on the heat sink with a small blocking mirror attached.

### DETAILED DESCRIPTION OF THE INVENTION

Embodiments of the invention are described herein with reference to schematic illustrations of embodiments of the invention. Embodiments of the invention should not be construed as limited to the particular shapes of the regions illustrated herein but are to include deviations in shapes that result, for example, from manufacturing techniques and/or tolerances. A region illustrated or described as square or rectangular will typically have rounded or curved features due to normal manufacturing tolerances. Thus, the regions illustrated in the figures are schematic in nature and their shapes are not intended to illustrate the precise shape of a region of a device and are not intended to limit the scope of the invention.

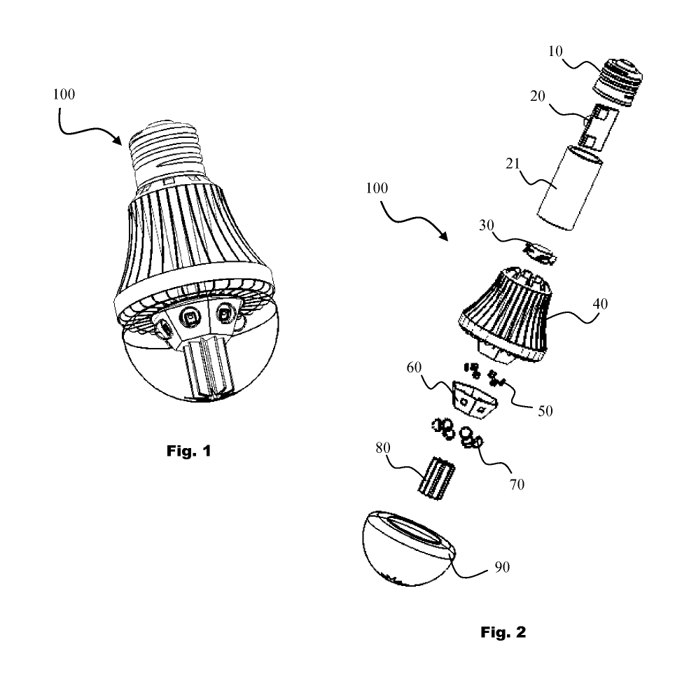

The present invention will now be described with reference to FIG. 1. While various shapes of the lighting devices are within the scope of the present invention, the preferred embodiment of the present invention has a shape and form factor closely resembling the incandescent light bulb. In a particular embodiment, the combined shape of the heat sink and the output globe forms a standard A19 light bulb shape 100.

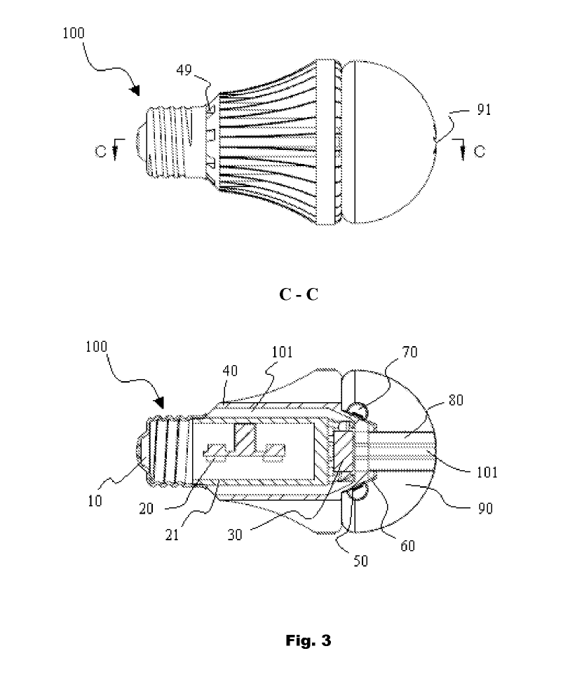

As illustrated in FIG. 2 and FIG. 3, in one of the preferred embodiments, the LED lighting device 100 of the present invention comprises an electrical connector 10, an electrical AC/DC conversion and control driver 20, a driver housing 21, a heat sink 40, a plurality of semiconductor light emitting diodes (LEDs) 50, a reflective cap 60, a plurality of remote phosphor caps 70, an air pipe 80, and an output globe 90. The heat sink 40 and the air pipe 80 form a channel 101 substantially around the centerline of the LED lighting device 100. The output globe 90 has an opening 91 and the heat sink 40 has a plurality of openings 49 to provide air intake or exhaust for the channel 101. When the lighting device is turned on, the heat generated by the LEDs 50 and the driver 20 will heat the air inside the channel 101, and the warm air rises and creates a convective force. This convective force will help move the air through the channel 101 and remove heat from the lighting devices 100. In another preferred embodiment, the LED lighting device 100 of the present invention uses an active cooling device 30 such as a cooling fan or a synthetic jet inside the channel 101 to introduce forced convection for further improvement of heat removal. These arrangements reduce the required heat sink volume greatly. Therefore, the lighting device 100 with high luminous output can still have a form and shape factor similar to traditional incandescent lighting apparatus.

The electrical power connector 10 of the lighting device may be a standard Edison-type screw connector such that the lighting device can be used to replace a standard incandescent light bulb.

FIG. 4a and FIG. 4b illustrate the heat sink 40 according to the preferred embodiment of the present invention viewed from two different angles. The heat sink 40 has a cylindrical main body 41 with fins 42 on its outside surface for heat dissipation. Near its upper edge, the heat sink 40 has a plurality of openings 49. Inside the heat sink 40, a cutout substantially around the centerline in the upper portion forms an upper housing 43 to host the electronics, which include the electrical AC/DC conversion and control driver 20 and its housing 21, and the active cooling device 30 if used. The heat sink 40 has a frustum 44 extended down from its cylindrical main body 41. This frustum 44 has a plurality of side surfaces 45. The LEDs are mounted on these side surfaces and emit light outwards and slightly downwards. Inside the frustum 44, there is a through-hole 46 connecting the frustum's top surface to the upper housing 43 so that a tunnel is formed substantially around the centerline of the heat sink 40. An air channel is then formed after attaching the air pipe 80 to the frustum's opening. The contour diameter of the fins 42 gradually increases starting from the heat sink's upper edge to the base of the frustum 44 to form a pear contour shape. A ring 47 connects all the fins 42 at the lower end around the base of the frustum 44. The ring 47 can facilitate easy handling of the lighting device. The gaps 48 between the heat sink's main body 41 and the ring 47 allow light to pass through to reach a substantially large portion of the upper hemisphere of the lighting device. It is further understood that the through-hole 46 can be cut with many different hole opening sizes and shapes including circular, oval, rectangular, hexagonal, star or other multiple side shapes. In general, the bigger the surface area, the better the convective heat dissipation.

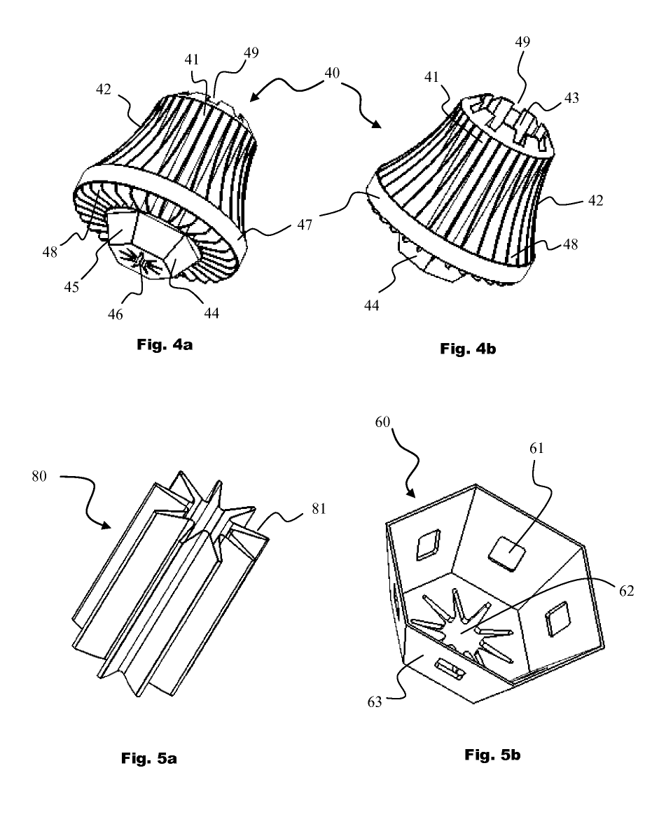

As illustrated in FIG. 5a, the air pipe 80 according to the preferred embodiment of the present invention is a thin pipe that can have a variety of cross-section shapes 81, including circular, oval, rectangular, hexagonal, star or other multiple side shapes. It has a relatively small cross-section size so that it will not form any light shadows. The air pipe 80 can be made of either thermally conductive material such as metals, or thermally non-conductive materials such as plastics, with its outside surfaces coated with highly reflective paint. The air pipe 80 has a tight fit with the output globe's opening 91 and the through-hole 46 of the heat sink's frustum. 44.

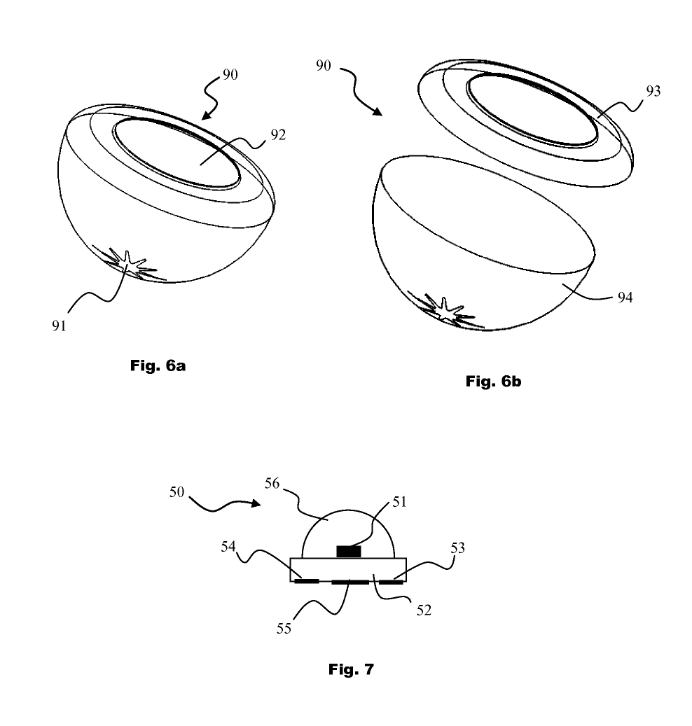

As illustrated in FIG. 6a, in some of the preferred embodiments of the present invention, the output globe 90 has a hemisphere shape with a diameter larger than the diameter of the heat sink's main cylindrical body 41, but roughly equal to the diameter of the handling ring 47. Also, the upper portion of the output globe is shaped in such a way that its upper opening 92 can have a tight fit with the heat sink's main cylindrical body 41 near the base of the frustum 44. At the bottom of the output globe 90, there is another opening 91 that provides air passage for the air channel 101. It is further understood that the opening 91 can be cut with many different hole opening sizes and shapes including circular, oval, rectangular, hexagonal, star or other multiple side shapes. Together with the air pipe 80, the output globe 90 and the heat sink 40 form an airtight space surrounding the LEDs 50. The output globe 90 is made of translucent material with a substantial amount of light being diffusively reflected. Part of the reflected light will be recycled by the reflective cap 60. A substantial portion of the reflected light will go through the gaps 48 between the fins 42 to reach the upper hemisphere so that omni-directional lighting is realized.

As illustrated in FIG. 6b, in some other preferred embodiments of the present invention, the output globe 90 comprises two separate pieces: the upper cover 93 and the lower globe 94. The upper cover 93 and the lower globe 94 have a tight fit. The upper cover 93 is made of substantially transparent material, while the lower globe 94 is made of translucent material with a substantial amount of light being diffusively reflected. Part of the reflected light will be recycled by the reflective cap 60. A substantial portion of the reflected light will go through the upper cover 93 and the gaps 48 between the fins 42 to reach the upper hemisphere. Therefore, omni-directional lighting is realized. In some other embodiments of the present invention, both the upper cover 93 and the lower globe 94 can be made of substantially transparent material with light diffusing features on their surfaces, such as light shaping diffusers based on holography technology.

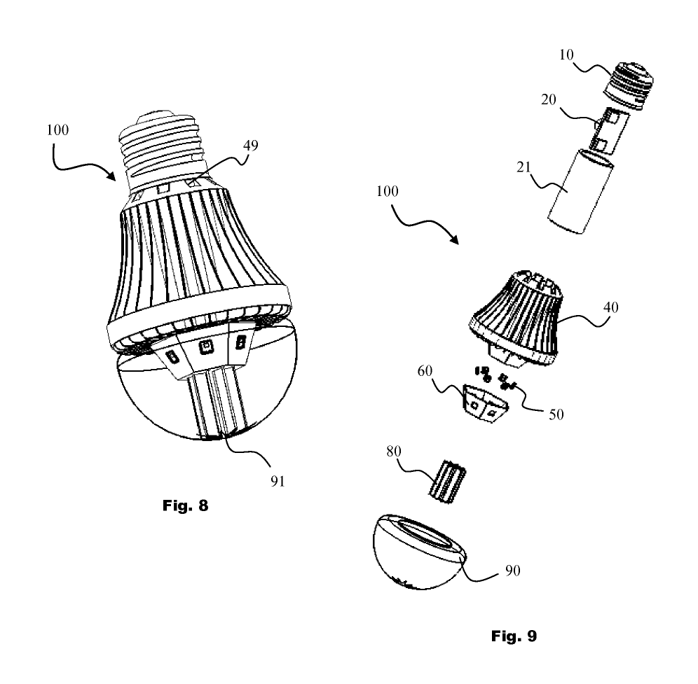

FIG. 7 illustrates a typical LED 50. The LED 50 typically consists of a light-emitting element called the LED die or LED chip 51, a chip carrier called sub-mount 52, an electrical lead anode 53, an electrical lead cathode 54, a thermal pad 55, and a lens 56. The sub-mount 52 is usually thermally conductive but electrically non-conductive. More than one LED chip can be packaged into the same sub-mount as well. The LEDs are commercially available from a number of manufacturers, such as Cree, Philips Lumileds, and Osram. These manufacturers also supply LEDs with or without phosphors included in the package. Cool white light LEDs and warm white light LEDs that have phosphors embedded in the lens material are commercially available from Cree, Philip Lumileds, Osram, etc. These LEDs can be used in the present invention to produce a complete LED lighting device with color rendering index (CRI) specified by the LED vendors. In some other ways to achieve desired high color rendering index (CRI), the LED lighting device of the present invention may utilize a few groups of LEDs in some embodiments, with each group of LEDs emitting a different dominant wavelength. Different colors of light are mixed within the output globe.

As illustrated in FIG. 5b, the reflective cap 60 is a thin cap with a shape closely matching the frustum 44 of the heat sink 40. It has a plurality of openings 61 that have tight fits with the output lens 56 of the LEDs 50. It also has an opening 62 that has a tight fit with the air pipe 80. The reflective cap 60 is made of highly reflective material, or has highly reflective material coated on its outside side surfaces 63. The reflective cap 60 sits right on top of the heat sink's frustum 44.

There have been extensive studies on achieving warm white light using blue LEDs or near-UV LEDs in combination with remote phosphors. Blue light LEDs or near-UV LEDs are commercially available from Cree, Philip Lumileds, Osram, etc. In some preferred embodiments of the present invention, these LEDs can be used together with the remote phosphor caps 70 to produce a complete LED lighting device with high color rendering index (CRI). These remote phosphor caps are made of substantially transparent plastic material that is embedded with phosphor particles. In some other embodiments, the LED lighting device of the present invention may utilize a first group of blue or UV LEDs that is capped by the remote phosphor caps, and a second group of green or red LEDs. This second group of green or red LEDs is to make up for the color deficiency of the light emerging from the remote phosphor caps 70. Different colors of light are mixed within the output globe. As a result, high color rendering index (CRI) is achieved.

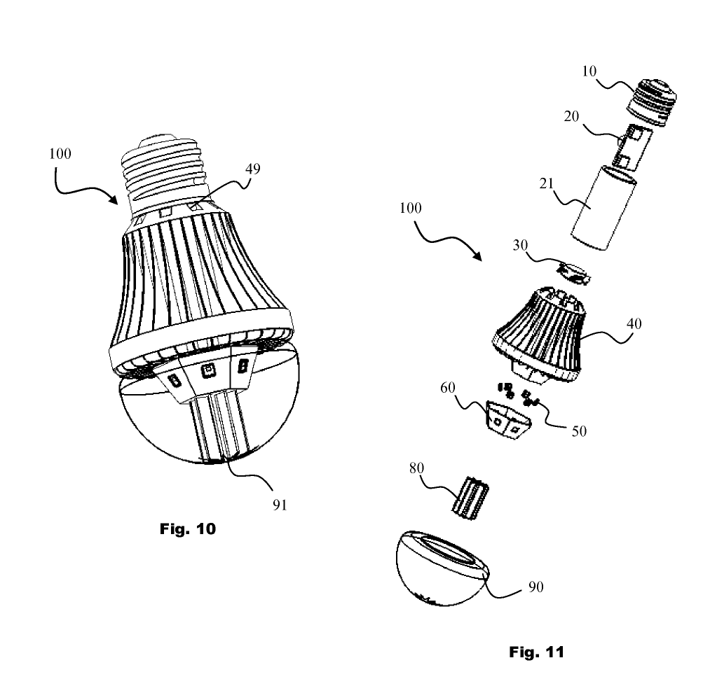

The preferred embodiments of the present invention will now be described with reference to FIG. 8, FIG. 9 and other sub-component or module drawings from FIG. 4a to FIG. 7. In a first preferred embodiment of the present invention, the LED lighting device 100 comprises an electrical connector 10, an electrical AC/DC conversion and control driver 20, a driver housing 21, a heat sink 40, a plurality of semiconductor light emitting diodes (LEDs) 50, a reflective cap 60, an air pipe 80, and an output globe 90. The heat sink 40 and the air pipe 80 form a channel 101 substantially around the centerline of the LED lighting device 100. The output globe 90 has an opening 91 and the heat sink 40 has a plurality of openings 49 to provide air intake or exhaust for the channel 101. The LEDs 50 are the cool white light LEDs or warm white light LEDs that have phosphors embedded in the lens material, commercially available from Cree, Philip Lumileds, Osram, etc. The lighting devices 100 will have a color rendering index (CRI) equal to the CRI of the LEDs 50 specified by the LED vendors. The heat sink 40 has a cylindrical main body 41 with fins 42 on its outside surface for heat dissipation. There are a plurality of openings 49 around the upper edge of the heat sink 40 that provides openings for the air channel 101. Inside the heat sink 40, a cutout substantially around the centerline in the upper portion forms an upper housing 43 to host the electronics, which include the electrical AC/DC conversion and control driver 20 and its housing 21. The heat sink 40 has a frustum 44 extended down from its cylindrical main body 41. This frustum 44 has a plurality of side surfaces 45. The LEDs are mounted on these side surfaces and emit light outwards and slightly downwards. Inside the frustum 44, there is a through-hole 46 connecting the frustum's top surface to the upper housing 43 so that a tunnel is formed substantially around the centerline of the heat sink 40. An air channel 101 is then formed after attaching the air pipe 80 to the frustum's opening. The contour diameter of the fins 42 gradually increases starting from the heat sink's upper edge to the base of the frustum 44 to form a pear contour shape. A ring 47 connects all the fins 42 at the lower end around the base of the frustum 44. The ring 47 can facilitate easy handling of the lighting device. The gaps 48 between the heat sink's main body 41 and the ring 47 allow light to pass through to reach a substantially large portion of the upper hemisphere of the lighting device, so that omni-directional light is realized. When the lighting device 100 is turned on, the heat generated by the LEDs 50 and the driver 20 will heat the air inside the channel 101, and the warm air rises and creates a convective force. This convective force will help move the air through the channel 101 and remove heat from the lighting devices 100. The output globe 90 has a hemisphere shape with a diameter larger than the diameter of the heat sink's main cylindrical body 41, but roughly equal to the diameter of the handling ring 47. Also, the upper portion of the output globe is shaped in such a way that its upper opening 92 can have a tight fit with the heat sink's main cylindrical body 41 near the base of the frustum 44. At the bottom of the output globe 90, there is another opening 91 that provides air passage for the air channel 101. Together with the air pipe 80, the output globe 90 and the heat sink 40 form an airtight space surrounding the LEDs 50. The output globe 90 is made of translucent material with a substantial amount of light being diffusively reflected. The reflective cap 60 will recycle part of the reflected light. A substantial portion of the reflected light will go through the gaps 48 between the fins 42 to reach the upper hemisphere so that omni-directional lighting is realized.

As illustrated in FIG. 10, FIG. 11 and other sub-component and module drawings from FIG. 4a to FIG. 7, in a second preferred embodiment of the present invention, the LED lighting device 100 comprises an electrical connector 10, an electrical AC/DC conversion and control driver 20, a driver housing 21, a heat sink 40, a plurality of semiconductor light emitting diodes (LEDs) 50, a reflective cap 60, an air pipe 80, and an output globe 90. The heat sink 40 and the air pipe 80 form a channel 101 substantially around the centerline of the LED lighting device 100. The output globe 90 has an opening 91 and the heat sink 40 has a plurality of openings 49 to provide air intake or exhaust for the channel 101. The LEDs 50 are the cool white light LEDs or warm white light LEDs that have phosphors embedded in the lens material, commercially available from Cree, Philip Lumileds, Osram, etc. The lighting devices 100 will have a color rendering index (CRI) equal to the CRI of the LEDs 50 specified by the LED vendors. The heat sink 40 has a cylindrical main body 41 with fins 42 on its outside surface for heat dissipation. Inside the heat sink 40, a cutout substantially around the centerline in the upper portion forms an upper housing 43 to host the electronics, which include the electrical AC/DC conversion and control driver 20 and its housing 21. The heat sink 40 has a frustum 44 extended down from its cylindrical main body 41. This frustum 44 has a plurality of side surfaces 45. The LEDs 50 are mounted on these side surfaces and emit light outwards and slightly downwards. Inside the frustum 44, there is a through-hole 46 connecting the frustum's top surface to the upper housing 43 so that a tunnel is formed substantially around the centerline of the heat sink 40. An air channel 101 is then formed after attaching the air pipe 80 to the frustum's opening. The contour diameter of the fins 42 gradually increases starting from the heat sink's upper edge to the base of the frustum 44 to form a pear contour shape. A ring 47 connects all the fins 42 at the lower end around the base of the frustum 44. The ring 47 can facilitate easy handling of the lighting device. The gaps 48 between the heat sink's main body 41 and the ring 47 allow light to pass through to reach a substantially large portion of the upper hemisphere of the lighting device, so that omni-directional light is realized. When the lighting device is turned on, the heat generated by the LEDs 50 and the driver 20 will heat the air inside the channel 101, and the warm air rises and creates a convective force. This convective force will help move the air through the channel 101 and remove heat from the lighting devices 100. An active cooling device 30 such as a cooling fan or a synthetic jet is installed between the housing 21 and the frustum 44 inside the channel 101 to introduce forced convection for further improvement of heat removal. These arrangements reduce the required heat sink volume greatly. Therefore, the lighting device 100 with high luminous output can still have a form and shape factor similar to traditional incandescent lighting apparatus. The output globe 90 has a hemisphere shape with a diameter larger than the diameter of the heat sink's main cylindrical body 41, but roughly equal to the diameter of the handling ring 47. Also, the upper portion of the output globe is shaped in such a way that its upper opening 92 can have a tight fit with the heat sink's main cylindrical body 41 near the base of the frustum 44. At the bottom of the output globe 90, there is another opening 91 that provides air passage for the air channel 101. Together with the air pipe 80, the output globe 90 and the heat sink 40 form an airtight space surrounding the LEDs 50. The output globe 90 is made of translucent material with a substantial amount of light being diffusively reflected. The reflective cap 60 will recycle part of the reflected light. A substantial portion of the reflected light will go through the gaps 48 between the fins 42 to reach the upper hemisphere so that omni-directional lighting is realized.

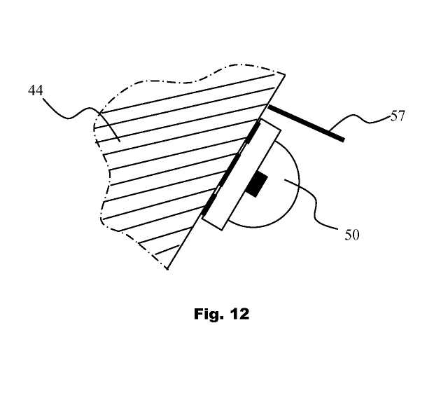

In a third preferred embodiment of the present invention, all other arrangements are identical to the first embodiment described earlier, except that the output globe 90 comprises two separate pieces: the upper cover 93 and the lower globe 94. The upper cover 93 and the lower globe 94 have a tight fit. The upper cover 93 is made of substantially transparent material, while the lower globe 94 is made of translucent material with a substantial amount of light being diffusively reflected. As illustrated in FIG. 12, to make sure no light can escape from the output globe 90 without at least being diffusely reflected at least once, a small mirror 57 is positioned right beside the LED 50 to deflect some of the light.

In a fourth preferred embodiment of the present invention, all other arrangements are identical to the second embodiment described earlier, except that the output globe 90 comprises two separate pieces: the upper cover 93 and the lower globe 94. The upper cover 93 and the lower globe 94 have a tight fit. The upper cover 93 is made of substantially transparent material, while the lower globe 94 is made of translucent material with a substantial amount of light being diffusively reflected. As illustrated in FIG. 12, to make sure no light can escape from the output globe 90 without being diffused at least once, a small mirror 57 is positioned right beside the LED 50 to deflect some of the light.

As illustrated in FIG. 10, FIG. 11 and other sub-component and module drawings from FIG. 4a to FIG. 7, in a fifth preferred embodiment of the present invention, the LED lighting device 100 comprises an electrical connector 10, an electrical AC/DC conversion and control driver 20, a driver housing 21, a heat sink 40, a plurality of semiconductor light emitting diodes (LEDs) 50, a reflective cap 60, an air pipe 80, and an output globe 90. The heat sink 40 and the air pipe 80 form a channel 101 substantially around the centerline of the LED lighting device 100. The output globe 90 has an opening 91 and the heat sink 40 has a plurality of openings 49 to provide air intake or exhaust for the channel 101. The LEDs 50 comprise two groups: a plurality first group of cool white LEDs 50 that lack red light component and a plurality second group of red LEDs 50 that emit light with a dominant wavelength around 630 nm. The two groups of LEDs 50 are mounted in such a way that different colors of light can be effectively mixed within the output globe 90 to achieve desired high color rendering index (CRI). The heat sink 40 has a cylindrical main body 41 with fins 42 on its outside surface for heat dissipation. Inside the heat sink 40, a cutout substantially around the centerline in the upper portion forms an upper housing 43 to host the electronics, which include the electrical AC/DC conversion and control driver 20 and its housing 21. The heat sink 40 has a frustum 44 extended down from its cylindrical main body 41. This frustum 44 has a plurality of side surfaces 45. The LEDs are mounted on these side surfaces and emit light outwards and slightly downwards. Inside the frustum 44, there is a through-hole 46 connecting to the upper housing 43 so that a tunnel is formed substantially around the centerline of the heat sink 40. An air channel 101 is then formed after attaching the air pipe 80 to the frustum's opening. The contour diameter of the fins 42 gradually increases starting from the heat sink's upper edge to the base of the frustum 44 to form a pear contour shape. A ring 47 connects all the fins 42 at the lower end around the base of the frustum 44. The ring 47 can facilitate easy handling of the lighting device. The gaps 48 between the heat sink's main body 41 and the ring 47 allow light to pass through to reach a substantially large portion of the upper hemisphere of the lighting device, so that omni-directional lighting is realized. When the lighting device is turned on, the heat generated by the LEDs 50 and the driver 20 will heat the air inside the channel 101, and the warm air rises and creates a convective force. This convective force will help move the air through the channel 101 and remove heat from the lighting devices 100. An active cooling device 30 such as a cooling fan or a synthetic jet is installed between the housing 21 and the frustum 44 inside the channel 101 to introduce forced convection for further improvement of heat removal. These arrangements reduce the required heat sink volume greatly. Therefore, the lighting device 100 with high luminous output can still have a form and shape factor similar to traditional incandescent lighting apparatus. The output globe 90 has a hemisphere shape with a diameter larger than the diameter of the heat sink's main cylindrical body 41, but roughly equal to the diameter of the handling ring 47. Also, the upper portion of the output globe is shaped in such a way that its upper opening 92 can have a tight fit with the heat sink's main cylindrical body 41 near the base of the frustum 44. At the bottom of the output globe 90, there is another opening 91 that provides air passage for the air channel 101. Together with the air pipe 80, the output globe 90 and the heat sink 40 form an airtight space surrounding the LEDs 50. The output globe 90 is made of translucent material with a substantial amount of light being diffusively reflected. The reflective cap 60 will recycle part of the reflected light. A substantial portion of the reflected light will go through the gaps 48 between the fins 42 to reach the upper hemisphere so that omni-directional lighting is realized.

As illustrated in FIG. 10, FIG. 11 and other sub-component drawings from FIG. 4a to FIG. 7, in a sixth preferred embodiment of the present invention, the LED lighting device 100 comprises an electrical connector 10, an electrical AC/DC conversion and control driver 20, a driver housing 21, a heat sink 40, a plurality of semiconductor light emitting diodes (LEDs) 50, a reflective cap 60, an air pipe 80, and an output globe 90. The heat sink 40 and the air pipe 80 form a channel 101 substantially around the centerline of the LED lighting device 100. The output globe 90 has an opening 91 and the heat sink 40 has a plurality of openings 49 to provide air intake or exhaust for the channel 101. The LEDs 50 comprise two groups: a plurality first group of LEDs 50 that has red phosphor embedded in their lens material but lack green light component, and a plurality second group of green LEDs 50 that emit light with a dominant wavelength around 570 nm. The two groups of LEDs 50 are mounted on the frustum's side surfaces in such a way that different colors of light can be effectively mixed within the output globe 90 to achieve desired high color rendering index (CRI). The heat sink 40 has a cylindrical main body 41 with fins 42 on its outside surface for heat dissipation. Inside the heat sink 40, a cutout substantially around the centerline in the upper portion forms an upper housing 43 to host the electronics, which include the electrical AC/DC conversion and control driver 20 and its housing 21. The heat sink 40 has a frustum 44 extended down from its cylindrical main body 41. This frustum 44 has a plurality of side surfaces 45. The LEDs are mounted on these side surfaces and emit light outwards and slightly downwards. Inside the frustum 44, there is a through-hole 46 connecting to the upper housing 43 so that a tunnel is formed substantially around the centerline of the heat sink 40. An air channel 101 is then formed after attaching the air pipe 80 to the frustum's opening. The contour diameter of the fins 42 gradually increases starting from the heat sink's upper edge to the base of the frustum 44 to form a pear contour shape. A ring 47 connects all the fins 42 at the lower end around the base of the frustum 44. The ring 47 can facilitate easy handling of the lighting device. The gaps 48 between the heat sink's main body 41 and the ring 47 allow light to pass through to reach a substantially large portion of the upper hemisphere of the lighting device, so that omni-directional lighting is realized. When the lighting device is turned on, the heat generated by the LEDs 50 and the driver 20 will heat the air inside the channel 101, and the warm air rises and creates a convective force. This convective force will help move the air through the channel 101 and remove heat from the lighting devices 100. An active cooling device 30 such as a cooling fan or a synthetic jet is installed between the housing 21 and the frustum 44 inside the channel 101 to introduce forced convection for further improvement of heat removal. These arrangements reduce the required heat sink volume greatly. Therefore, the lighting device 100 with high luminous output can still have a form and shape factor similar to traditional incandescent lighting apparatus. The output globe 90 has a hemisphere shape with a diameter larger than the diameter of the heat sink's main cylindrical body 41, but roughly equal to the diameter of the handling ring 47. Also, the upper portion of the output globe is shaped in such a way that its upper opening 92 can have a tight fit with the heat sink's main cylindrical body 41 near the base of the frustum 44. At the bottom of the output globe 90, there is another opening 91 that provides air passage for the air channel 101. Together with the air pipe 80, the output globe 90 and the heat sink 40 form an airtight space surrounding the LEDs 50. The output globe 90 is made of translucent material with a substantial amount of light being diffusively reflected. The reflective cap 60 will recycle part of the reflected light. A substantial portion of the reflected light will go through the gaps 48 between the fins 42 to reach the upper hemisphere so that omni-directional lighting is realized.

As illustrated in FIG. 1, FIG. 2, FIG. 3 and other sub-component drawings from FIG. 4a to FIG. 7, in a seventh preferred embodiment of the present invention, the LED lighting device 100 comprises an electrical connector 10, an electrical AC/DC conversion and control driver 20, a driver housing 21, a heat sink 40, a plurality of semiconductor light emitting diodes (LEDs) 50, a reflective cap 60, a plurality of phosphor caps 70, an air pipe 80, and an output globe 90. The heat sink 40 and the air pipe 80 form a channel 101 substantially around the centerline of the LED lighting device 100. The output globe 90 has an opening 91 and the heat sink 40 has a plurality of openings 49 to provide air intake or exhaust for the channel 101. The LEDs 40 are blue LEDs with dominant wavelength around 450 nm to 460 nm. The phosphor caps 70 are embedded with phosphors that convert the blue light into warm white light with high color rendering index (CRI). These phosphor caps 70 cover the blue LEDs 40 and attached to the reflective cap 60. The heat sink 40 has a cylindrical main body 41 with fins 42 on its outside surface for heat dissipation. Inside the heat sink 40, a cutout substantially around the centerline in the upper portion forms an upper housing 43 to host the electronics, which include the electrical AC/DC conversion and control driver 20 and its housing 21. The heat sink 40 has a frustum 44 extended down from its cylindrical main body 41. This frustum 44 has a plurality of side surfaces 45. The LEDs are mounted on these side surfaces and emit light outwards and slightly downwards. Inside the frustum 44, there is a through-hole 46 connecting to the upper housing 43 so that a tunnel is formed substantially around the centerline of the heat sink 40. An air channel 101 is then formed after attaching the air pipe 80 to the frustum's opening. The contour diameter of the fins 42 gradually increases starting from the heat sink's upper edge to the base of the frustum 44 to form a pear contour shape. A ring 47 connects all the fins 42 at the lower end around the base of the frustum 44. The ring 47 can facilitate easy handling of the lighting device. The gaps 48 between the heat sink's main body 41 and the ring 47 allow light to pass through to reach a substantially large portion of the upper hemisphere of the lighting device, so that omni-directional lighting is realized. When the lighting device is turned on, the heat generated by the LEDs 50 and the driver 20 will heat the air inside the channel 101, and the warm air rises and creates a convective force. This convective force will help move the air through the channel 101 and remove heat from the lighting devices 100. An active cooling device 30 such as a cooling fan or a synthetic jet is installed between the housing 21 and the frustum 44 inside the channel 101 to introduce forced convection for further improvement of heat removal. These arrangements reduce the required heat sink volume greatly. Therefore, the lighting device 100 with high luminous output can still have a form and shape factor similar to traditional incandescent lighting apparatus. The output globe 90 has a hemisphere shape with a diameter larger than the diameter of the heat sink's main cylindrical body 41, but roughly equal to the diameter of the handling ring 47. Also, the upper portion of the output globe is shaped in such a way that its upper opening 92 can have a tight fit with the heat sink's main cylindrical body 41 near the base of the frustum 44. At the bottom of the output globe 90, there is another opening 91 that provides air passage for the air channel 101. Together with the air pipe 80, the output globe 90 and the heat sink 40 form an airtight space surrounding the LEDs 50. The output globe 90 is made of translucent material with a substantial amount of light being diffusively reflected. The reflective cap 60 will recycle part of the reflected light. A substantial portion of the reflected light will go through the gaps 48 between the fins 42 to reach the upper hemisphere so that omni-directional lighting is realized.

Although the present invention is illustrated in connection with specific embodiments for instructional purposes, the present invention is not limited thereto. Various combinations, adaptations and modifications may be made without departing from the scope of the invention. Therefore, the spirit and scope of the appended claims should not be limited to the foregoing description.

### CITATION LIST

### U.S. Patent Documents

7,600,882 B1 10/2009 Morejon et al
7,744,243 B2 6/2011 Van De Ven et al
7,909,481 B1 3/2011 Zhang et al
7,960,872 B1 6/2011 Zhai et al
2011/0080096 A14/2011 Dudik et al

What is claimed is:

1. An LED lighting device comprising:
an electrical connector;
an electrical AC/DC conversion and control driver;
a heat sink having a first end and a second end, and having at least one opening near its first end;
a plurality of semiconductor light emitting diodes (LEDs);
an output globe having at least one opening, and
a heat removal means comprising at least one ventilation channel connecting the opening of the output globe and the opening of the heat sink.

2. The LED lighting device of claim 1, wherein the output globe is attached to the second end of the heat sink, and the heat sink and the output globe form a standard A19 light bulb shape with an Edison screw as the electrical connector attached to the first end of the heat sink.

3. The LED lighting device of claim 1 further comprising an active cooling device installed inside the channel, whereby forced convection is introduced for improved heat removal.

4. The LED lighting device of claim 1, wherein the channel is substantially around the centerline of the lighting device.

5. The LED lighting device of claim 1, wherein the heat sink has a frustum at its second end and the frustum has a plurality of side surfaces on which the LEDs are mounted.

6. The LED lighting device of claim 5 further comprising an air pipe connecting the opening of the output globe and the second end of the heat sink, and the air pipe, the output globe and the heat sink form an airtight space surrounding the LEDs.

7. The LED lighting device of claim 6, wherein the air pipe and the heat sink are made into one single piece.

8. The LED lighting device of claim 6, wherein all the surfaces of the air pipe and the heat sink enclosed by the output globe have substantially high reflectivity that is specular or diffuse, or combination thereof.

9. The LED lighting device of claim 6, wherein the output globe comprises an upper cover and a lower globe.

10. The LED lighting device of claim 9, wherein the lower globe is made of translucent material or is made of substantially transparent material with a plurality of light diffusers, whereby the light is diffusively reflected and transmitted.

11. The LED lighting device of claim 9, wherein the upper cover is made of substantially transparent material, whereby a substantial portion of the light will go through the upper cover to realize omni-directional lighting.

12. The LED lighting device of claim 11, wherein each LED has a mirror nearby to prevent the light from exiting the output globe without being diffused at least once.

13. The LED lighting device of claim 5, wherein the LEDs are the blue LEDs emitting a dominant wavelength in the blue region, further comprising a plurality of caps that sit on top of each LED respectively and the caps are made of substantially transparent material embedded with wavelength conversion luminescent phosphor particles.

14. The LED lighting device of claim 5, wherein the LEDs further comprise a plurality of first group of semiconductor light emitting diodes (LEDs) with a primary color, and a plurality of second group of semiconductor light emitting diodes (LEDs) with a secondary color, whereby a high color rendering index (CRI) lighting device is achieved.

15. A method for making an LED lighting device comprising a heat sink having at least one opening and an output globe having at least one opening, the method comprising building at least one ventilation channel connecting the opening of the heat sink and the opening of the output globe.

16. The method of claim 15, wherein the output globe is attached to one end of the heat sink, and the heat sink and the output globe form a standard A19 light bulb shape with an Edison electrical connector attached to another end of the heat sink.

17. The method of claim 15, wherein the ventilation channel comprises an pipe connecting the opening of the output globe to the heat sink.

18. The method of claim 15 further comprising installing an active cooling device inside the ventilation channel, whereby forced convection is introduced for improved heat removal.

19. The method of claim 18, wherein the active cooling device is substantially close to the opening of the output globe or the opening of the heat sink.

20. The method of claim 17, wherein the air pipe has a cross-section of circular, oval, rectangular, hexagonal, star or other multiple side shapes.
